(19) United States
(12) Patent Application Publication
(10) Pub. No.: US 2006/0026030 A1
(43) Pub. Date: Feb. 2, 2006

(54) System and method for matching users

(76) Inventor: Jack Jacobs, Rockville, MD (US)

Correspondence Address: JACK JACOBS, 1140 HALESWORTH DRIVE, ROCKVILLE, MD, 20854, US

(21) Appl. No.: 11/190,747

(22) Filed: Jul. 27, 2005

Related U.S. Application Data
(60) Provisional application No. 60/593,031, filed on Aug. 2, 2004.

(51) Int. Cl. G06Q 99/00

(52) U.S. Cl. 705/1; 705/6

(57) ABSTRACT

Methods and systems are provided for matching senders of items with travelers willing to be couriers. Senders register items they wish to send. Couriers register itinerary details. A database process matches items awaiting delivery with couriers wishing to deliver. Other embodiments are also described, such as methods and systems for matching users for in-flight assistance, sharing of space in shipping containers, and mail-order forwarding.

### RELATED APPLICATIONS

This application claims priority to U.S. Provisional Application Ser. No. 60/593,031, entitled “Casual courier,” filed Aug. 2, 2004, which is incorporated by reference herein in its entirety.

### BACKGROUND

The invention relates to methods and systems for matching users, and more specifically to methods and systems for matching users for package delivery, in-flight assistance, sharing of space in shipping containers, and mail-order forwarding.

### SUMMARY

To send a package to its destination, a sender has only a few options: Overnight delivery service (“overnight”), traditional postal authority (“post”) or personal hand-delivery (“hand-delivery”). Each of the existing methods of delivery is deficient. Overnight is very expensive, post is slow and unreliable, and hand-delivery is limited to extremely valuable items.

By connecting users desiring package delivery with travelers willing to delivery packages, The Casual Courier (“TCC”) can offer worldwide package delivery service at the speed of overnight, the cost of post, and with the reliability of hand-delivery.

TCC is an internet-based system and method that allows users to find alternative ways to send items. To use the service, a user must log-on to an internet website (“website”). The user then chooses from one of the services listed on the website (“services”):
Package delivery: send a package with a casual courier
AirSitter® services: find in-flight assistance with children/elderly
Container sharing: share space in large shipment containers
Mail-order forwarding: send mail-order via casual courier

The user then registers a request for one of the chosen services by filling out a unique online registration form. The registration form records detailed information about the users' request. The information collected differs by service. For example, the package delivery request form records information about the location and destination of the package, and size and weight of the package. Whereas, the AirSitter request form records information about the caregivers' credentials or unique care sought. After recording the information on the database, a results table is displayed which identifies candidates to fulfill the user's request. One user may invite a matching user to carry-out the requested service by clicking a link that sends an automated email from the service to the matching user. Upon accepting the invitation, users independently arrange delivery details and fees.

For example, User A visits the website and selects TCC's package delivery service. User A registers online and describes the characteristics of the package that he wishes to deliver from origination X to destination Y. The website validates the user, and searches the secured databases for users that match the criteria indicated by User A. The database identifies User B as a positive match and updates both users unique MyTCC screen (i.e., results table). The users are anonymously identified to prevent user contact before purchasing the contact details from the website. User A selects “invite” from his MyTCC screen and an email message is sent to User B. The email asks User B to confirm his travel plans and intention to work as a “casual courier.” User B's MyTCC screen is simultaneously updated to show that he was invited by User A to carry a package during his upcoming trip from origination X to destination Y. User B clicks the “accept” hyperlink on his received email message or clicks the “accept” link on his MyTCC screen.

User A is notified electronically and on his MyTCC screen that User B has accepted his offer to provide courier services from origination X to destination Y for an agreed fee, Z. User A purchases the contact information of User B via his MyTCC screen, and places the fee that he wishes to pay User B in escrow with TCC. TCC holds the fee securely in escrow. User A contacts User B and arranges drop-off and delivery details of the package. User A and User B meet in a busy cafe, examine the contents of the package, and complete the “Courier Service Agreement” (“CSA”). The CSA identifies ownership of the package and other details of the transaction. Users exchange copies of one another's passports, and possession of the package is transferred from User A to User B for delivery. User B packs the package in an accessible location in his luggage. At the airport, User B discloses to security officials that he is carrying a package for User A and offers the package and CSA for inspection. User B arrives at the destination and delivers the package according to User A's specifications. Upon successful receipt of the package, User A sends User B an electronic payment code to access the courier's fee held in escrow by TCC. User B, clicks on the hyperlink contained in the email message from User A, and is prompted to logon to the website. Payment is then transferred to User A's bank account, credit card, or PayPal account. Electronic receipt is sent to User A notifying payment. Both User A and User B are sent an electronic survey form to rate the other's performance during the transaction. The survey results are recorded and used to represent the User's “TCC Rating”. TCC Rating is viewable from users' MyTCC screen, and used to facilitate courier selection.

In another embodiment, users may select the AirSitter service from the website. This service allows users to find a caretaker for elderly, special needs, infirm or young travelers, and provides a forum for caregivers to offer their services. A user that is searching for an AirSitter (or an AirSitter wishing to offer their services) must first log-on to the website and specify the details of their request. Users specify travel dates, origination location, trip destination, airline and flight information, and the special needs of the travelers which require assistance. AirSitters may also identify any special qualifications that they have and the fee that they require for services rendered.

In another embodiment, users may select the Share Container service from the website. This service allows users to share part of large cargo container shipments. This service is ideal for users who wish to send items that are too large or heavy for traditional delivery means, but alone can not fill the entire container. Therefore, users may rent or share space in their partially filled container to other parties for a fee. Users who are moving internationally, transporting numerous belongings and small-business are the main target markets for this service.

In another embodiment, users may select the Mail-Order service from the website. This service provides an alternative means of shipping products purchased online or from catalogue companies. Users must register for the service on the website and indicate the details of their request. Product description, origination, and destination are stored in the website database. After the website confirms an appropriate courier, the user may purchase the courier's contact information from the website. Then, the purchaser simply indicates the courier's mailing address when purchasing products online or from a catalogue company. The purchased products are mailed to the courier's address and, upon arrival, hand-delivered by the courier to the purchaser. The target market for this service is consumers living in locations where companies do not ship their products or will only ship their product for high delivery charges.

In another embodiment, users can search the website using a “Quick-Search” method. The quick-search method reduces the time required for filling out the service forms, and improves usability of the website. The quick-search method allows users to promptly select a service, the origin of the package and the destination of the package from a drop-down list on the home page. TCC databases then generally list, in table format, the appropriate matches for this request. The user may then click on the identified match and directed to the user's MyTCC screen. From there, the user may invite the courier identified from the quick search, purchase courier contact information and arrange delivery details.

In another embodiment, users can click on an Interactive World Map that shows where on the globe there are couriers awaiting packages to deliver and where there are senders seeking to deliver packages. When a user “rolls over” the destination on the interactive world map, a statistical analysis of the particular country identified is displayed, namely the total number of couriers and the total number of senders. Users may also see the statistics of worldwide couriers and senders by selecting the individual country from a comprehensive drop-down list located near the world map.

In another embodiment, users can find travel companionships, romantic involvements, friendships, or business associates by accessing the database. Users can search the database to find and match passengers with similar travel itineraries that have similar interests or traveling to similar destinations and interested in beginning a relationship. For example, the system can match passengers on airline flight with similar interests, and interested in developing a romantic relationship or dating. In another example, a user may wish to locate potential business clients during his train trip from London to Paris.

In another embodiment, users that are existing formal courier and shipping companies, or employ formal couriers or shippers to deliver items, like trucking companies and cargo companies, can access the database via direct interface or via website to find independent couriers or containers that are traveling to a particular destination and willing to carry an item, or share container cargo space with them on their journey to a particular destination. These particular users can use TCC's system and method to supplement their existing formal courier service, and/or offer TCC as a value added service, thereby adding a “casual courier” service to their existing business. Users can also use TCC to locate private and independent couriers as employees to their existing courier service. For example, a user trucking company may use TCC services to locate a “casual courier” driving a van from Los Angeles to New York and willing to take with him in his car a few extra boxes on his cross-country trip for a fee.

In another embodiment, travel agencies or online travel companies can log-on to the website and access the database on behalf of clients seeking to travel to a particular destination and wish to reduce the cost of travel expenses. Travel agencies and online travel companies and websites can incorporate the passengers' courier service into the ticket fee, thereby reducing cost of traveling and adding utility to an otherwise unproductive trip. For example, a travel agent may quote a customer $500 to fly from Boston to Miami; however, the price may be reduced to $400 if the customer agrees to deliver a package to Miami. Travel agents and travel agencies and airlines and bus companies and train companies and tour organizers and ticket sales agents and online travel companies and websites may access TCC's website via unique interface connected more directly into TCC proprietary database and system. TCC may also integrate with existing travel agency software and ticket service methods and with online travel websites, thereby adding “courier services” to passengers' choices when making travel arrangements.

In another embodiment, the services can be used for national and international travel. Users can use the services to deliver items locally, internationally, interstate, intrastate, long-distances, short-distance, or within the same town or city. Delivery by “casual courier” may be conducted by car, van, bus, truck, air travel (e.g., airplane), water travel (e.g., boat), or by pedestrian transport (e.g. walking or bicycle).

In another embodiment, users can use the services and unique database, systems and methods to locate and compare other existing courier service businesses, including trucking and shipping companies, and more formal traditional overnight, or hand delivery services. This embodiment can facilitate the determination of fees charged by couriers for their “casual courier” services. Also, this feature can be used to highlight and assess the value attained by users of the website and services offered by TCC. This embodiment can also be used to compare and contrast competing courier services. Courier and shipping companies may pay TCC an advertising fee to be included in this database, posting their services on a user price comparison table.

In another embodiment, the system can accommodate an “exclusive” service whereby TCC may select, guarantee and/or validate a number of “exclusive casual couriers” for especially valuable delivery or for demanding, high-level clientele. This embodiment may assist the delivery needs of users who wish to employ “casual couriers” but require additional assurances regarding the reliability of the courier.

In another embodiment, TCC may play a more active roll in accepting and collecting packages from users. Upon receiving packages from users, TCC may arrange the delivery of the packages to the appropriate destination by locating and organizing delivery with an appropriate, independent “casual courier”. Items may be verified, inspected, chemically analyzed and re-sealed before being handed over to a “casual courier” for delivery. In this embodiment, senders of package will bring the package to a casual courier agent or office location for inspection. After confirming the contents and sealing the package, TCC may act on the users' behalf to locate an appropriate and reliable “casual courier” who agrees to deliver the package for an established fee. “Casual couriers” may pick-up the package directly from the TCC agent or office and then deliver it to another TCC agent or office in the destination city, or deliver it directly to the recipient.

In another embodiment, TCC may take an active role in locating couriers to serve the sender's requirements. This active search for couriers by TCC may involve working with travel agencies and airlines and tour groups and organizations and frequent travel programs. In this embodiment, TCC may also advertise its services in an effort to draft independent couriers to deliver packages during their trips (See FIG. 17).

In another embodiment, the system establishes numerous methods for ensuring a safe user experience. Examples of TCC's security suggestions and safety policies include: users meeting in a public place when meeting to exchange the package, users exchanging photocopies of a photo identification card to prove users' identity, users signing an affidavit setting forth and attesting to the true contents of the package being delivered on senders' behalf, users thoroughly examining the contents of the items being sent, and fully-disclosing the contents of the items delivered to all security officials.

In another embodiment, TCC may insure items shipped via “casual courier” or other services offered on the website. In addition, TCC may refer users to independent insurance agents wishing to create an insurance policy for the item being delivered by “casual courier”. TCC may receive a commission fee for this referral to a partnered insurance company.

In another embodiment, users can deliver items for no fee at all, either for purposes of charity or good-heartedness or out of kindness for others. For example, users may volunteer to deliver clothing, food, water, medical supplies, emergency items, blankets, sleeping bags, eye glasses, shoes, gloves, children's toys, etc. to people in need around the world. Users could search the database and match people willing to take charitable or humanitarian items, to people in need around the world, or locally without paying any courier fees whatsoever (however, a matching fee to TCC may still apply).

### BRIEF DESCRIPTIONS OF THE DRAWINGS

FIG. 1 is a flow chart of the matching process—sender starts

FIG. 2 is flow chart of the matching process—courier starts

FIG. 3 is a timeline of matching process—sender starts

FIG. 4 is a timeline of matching process—courier starts

FIG. 5 is a flow chart of the quick search match process

FIG. 6 is a flow chart of the acceptance and payment processes

FIG. 7 is a flowchart of world map search

FIG. 7a is an image of the world map quick search feature from the website

FIG. 8 is a flowchart of the overall structure of website

FIG. 9 is a diagram of the overall structure of website

FIG. 10 is a flowchart for username and password validation

FIG. 11 is a flow chart for sender registration

FIG. 12 is a flow chart to show access to MyTCC screen

FIG. 13 is a flow chart of the escrow payment process

FIG. 14 is an image of the website homepage

FIG. 15 is an image of “Courier Service Agreement”

FIG. 16 is an image of results table with formal option

FIG. 17 is an image of possible advertisements

### DETAILED DESCRIPTION

A system is provided that matches senders of items with independent couriers. The system creates a forum for senders and couriers to meet, thereby establishing an alternative means to delivery packages worldwide. The system also facilitates the selection of available couriers by displaying a peer-generated reliability rating for each user, and also assists the payment of couriers by senders.

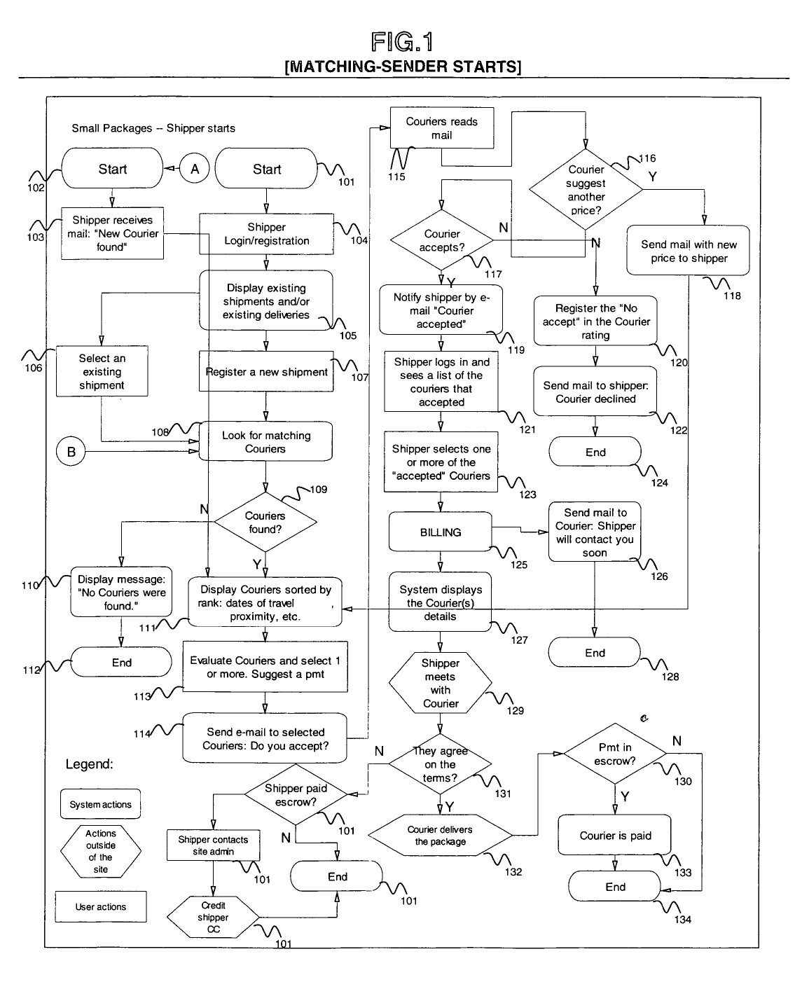

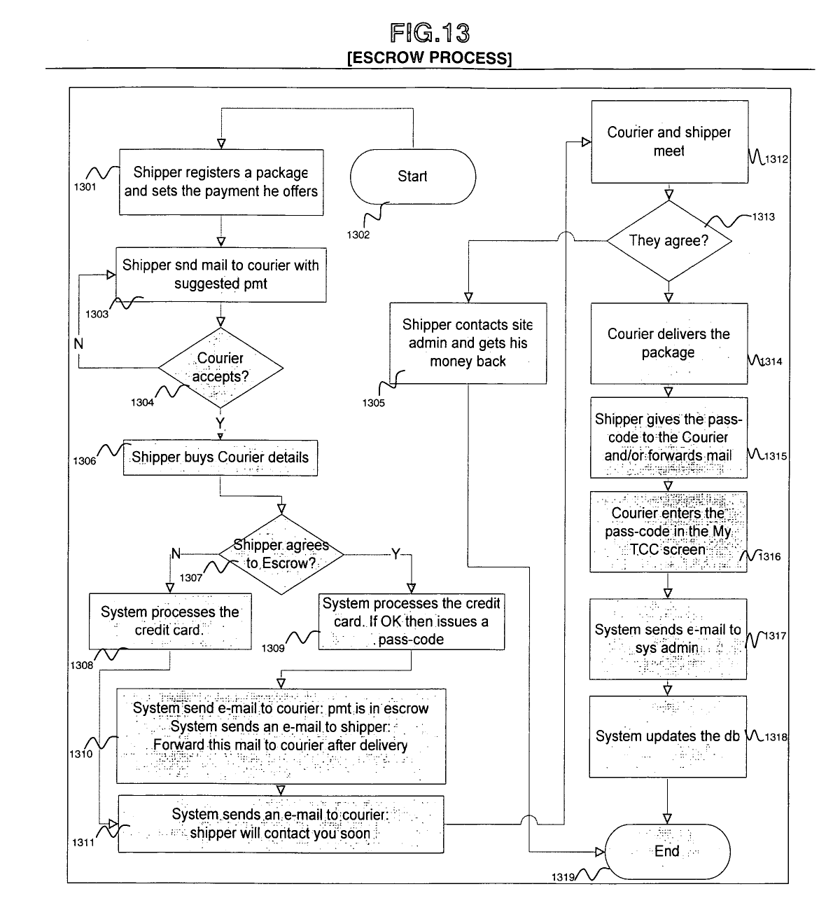

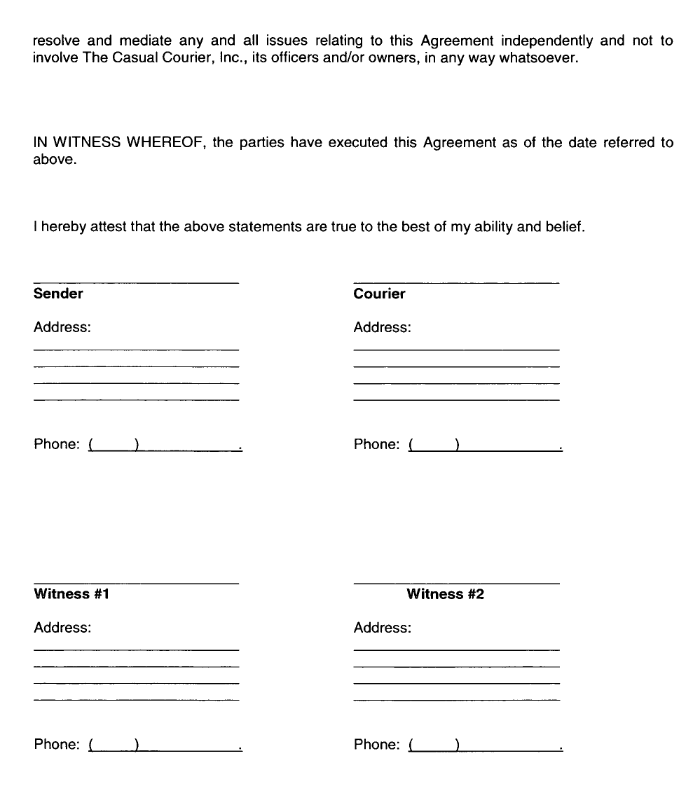

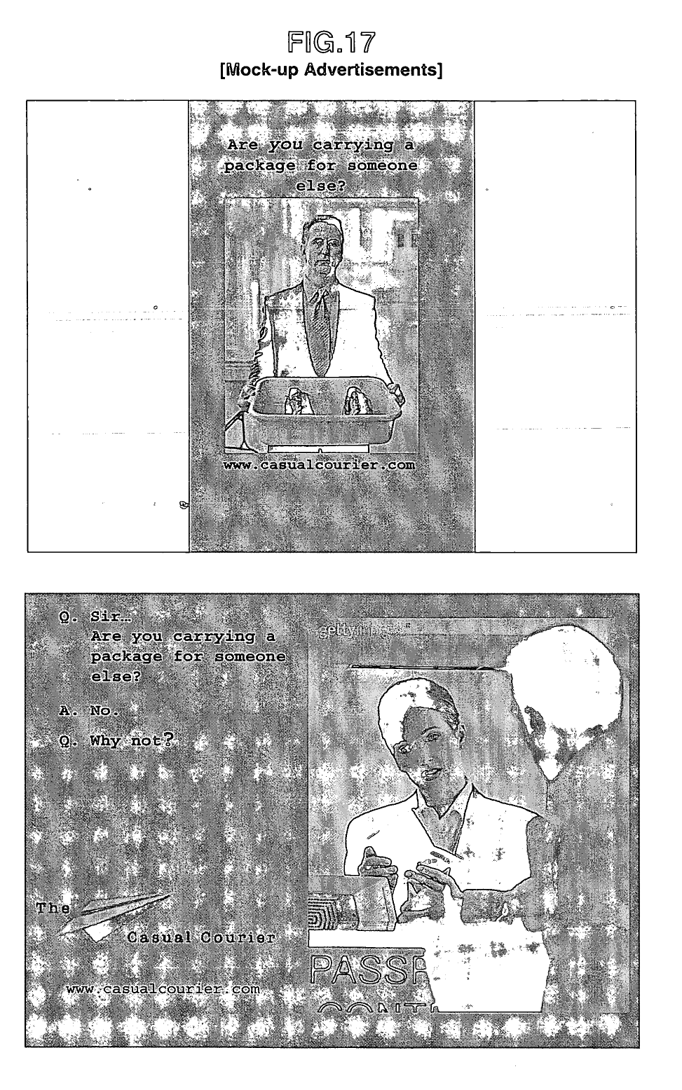

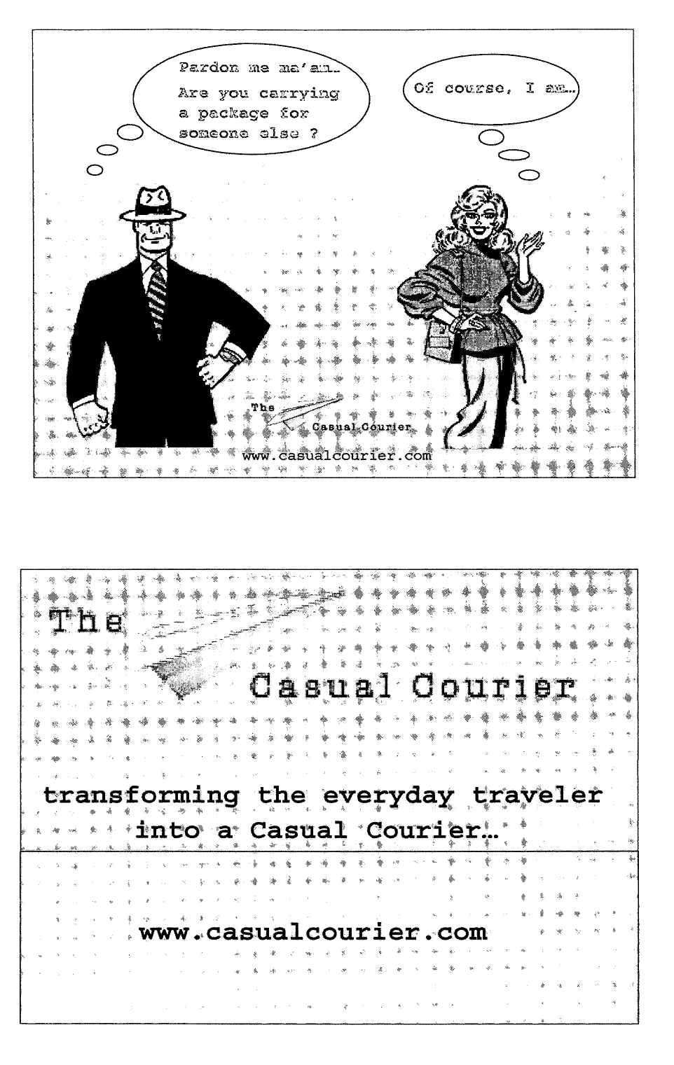

In one aspect, users can use the site to find a courier to deliver a package to its destination. For example, referring to FIG. 1, a flowchart for the matching process, a sender of a package (“sender”) sees a TCC advertisement (See FIG. 17) and visits the website (See FIG. 14). Sender registers 101 as a user of the website by recording sender's personal contact details 104. Sender's personalized “MyTCC” screen is then displayed 105 (See also FIG. 16). Next, sender clicks a service that he requires. Referring to FIG. 11, the services available may include: find a courier 1111, take a package 1112, container sharing 1113, AirSitter 1114, or Mail-Order 1115.

For example, sender chooses a new shipment delivery by casual courier 1111. Referring back to FIG. 1, after sender registers a new shipment 107, the system automatically searches the databases 108 for a user that meets the sender's criteria to carry out the request. When a courier is found 109 the sender can view general characteristics about the courier 111, including, courier identification number, peer-generated reliability rating score, point of departure/arrival, date of departure/arrival (See also FIG. 16). The sender reviews the matching couriers 113 and selects the most appropriate couriers to take his package. The sender selects the most appropriate courier based on proximity to the sender, and courier rating score (See FIG. 16). The sender invites his selected courier(s) to deliver the package for an independently determined fee offered by the sender 113.

The system automatically sends an email message 114 to the selected courier(s) requesting confirmation of couriers' desire to deliver a package for sender. When the courier(s) receive the email invitation to deliver a package 115 the courier(s) may immediately accept the invitation 117 thereby notifying the sender via email of the couriers' acceptance 121. The courier(s) may also renegotiate the payment for his services 116 by clicking the “suggest different fee” option located on his email invitation. At that point, the system sends email to the sender with the new suggested fee 118. The sender may then accept or reject the couriers' renegotiated fee. When a courier ultimately accepts the sender's invitation 121, the courier's status on the sender's MyTCC screen is updated 121 from “invited” to “accepted”. “Accepted” status 117 indicates that the specific courier has accepted the sender's invitation, confirmed his travel itinerary and agrees to fee determined by the sender. “Declined” status 120 indicates that the specific courier has not accepted the sender's invitation, usually because the courier has already accepted another sender's invitation, or changed his travel itinerary.

When one or more courier accepts the sender's invitation, the courier may purchase the contact information of any accepted courier 123. A billing screen appears 125 informing the sender that a matchmaking fee will be charged for providing the contact information. The sender is charged a “matchmaking fee” for revealing the courier's contact information 125 to the sender.

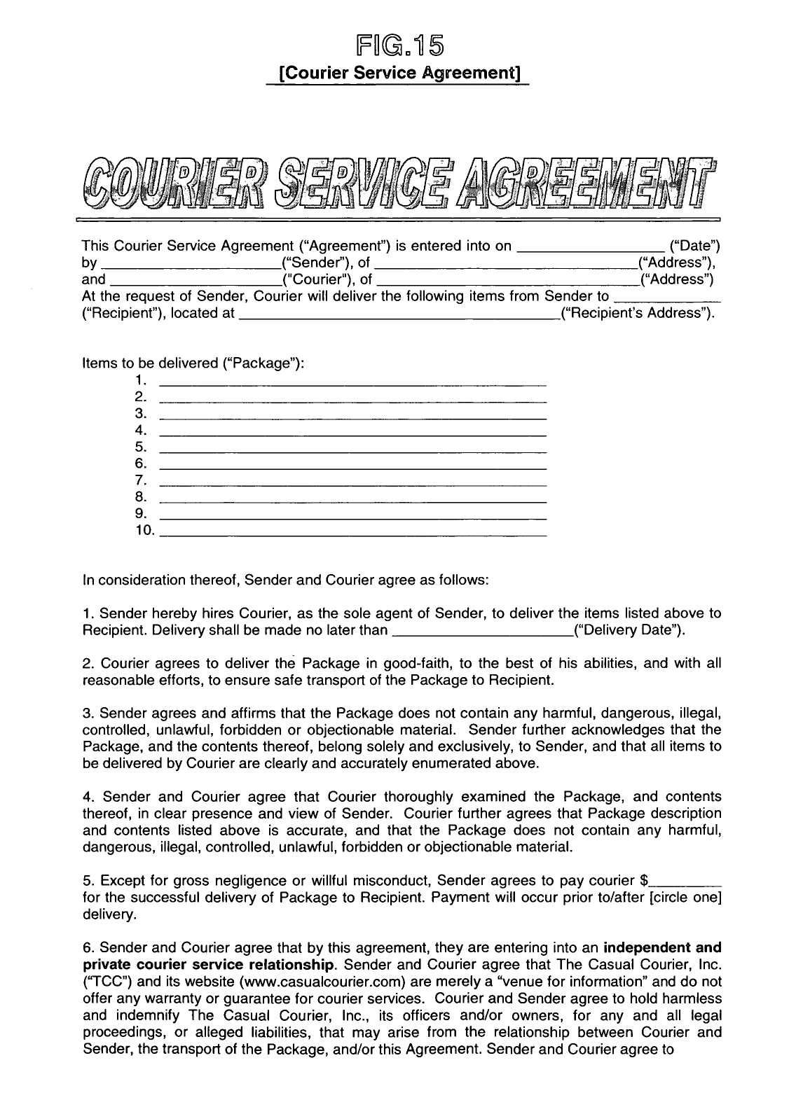

The site's billing screen also provides the sender with the option to hold the courier's fee in a secure escrow account until the package is safely delivered to its recipient. Referring to FIG. 13, a flowchart of the escrow payment process, upon requesting TCC's escrow service 1307, the system charges the sender's credit card for the full courier fee agreed upon 1309, and sends a confirmation email to the courier 1311 noting that the fee was paid by the sender and being held in escrow. A confirmation email is also sent to the sender 1310 which summarizes the transaction and records the total courier fee that is being held in escrow. The confirmation email to the sender also contains a unique payment code 1315. Upon successful delivery of the package 1314, the sender forwards the payment code to the courier 1315. (In the event that the package is not delivered, the sender may request a refund from the website 1305). The courier then logs on to the website 1316 and enters the pass code when prompted. The system then transfers the funds, minus a commission, to the courier's private money account 1317 (e.g., bank account, credit card, PayPal, etc.).

Users may choose to negotiate the payment terms of the transaction without employing the escrow feature. In this scenario, the sender simply deselects the escrow feature from the billing screen 1307 and purchases the contact information of the courier 1308. The system then sends an automated email message to the courier 1311 notifying the courier that a sender purchased his contact information and will contact him shortly 1311.

Referring back to FIG. 1, after verifying sender's payment transaction information 125 (e.g., credit card information), the contact information of the selected courier is revealed to the sender 127. Contact information may include: email address, phone number, geographic location and postal address 127. The sender then independently contacts the courier 129 and arranges a meeting to transfer possession of the package 129.

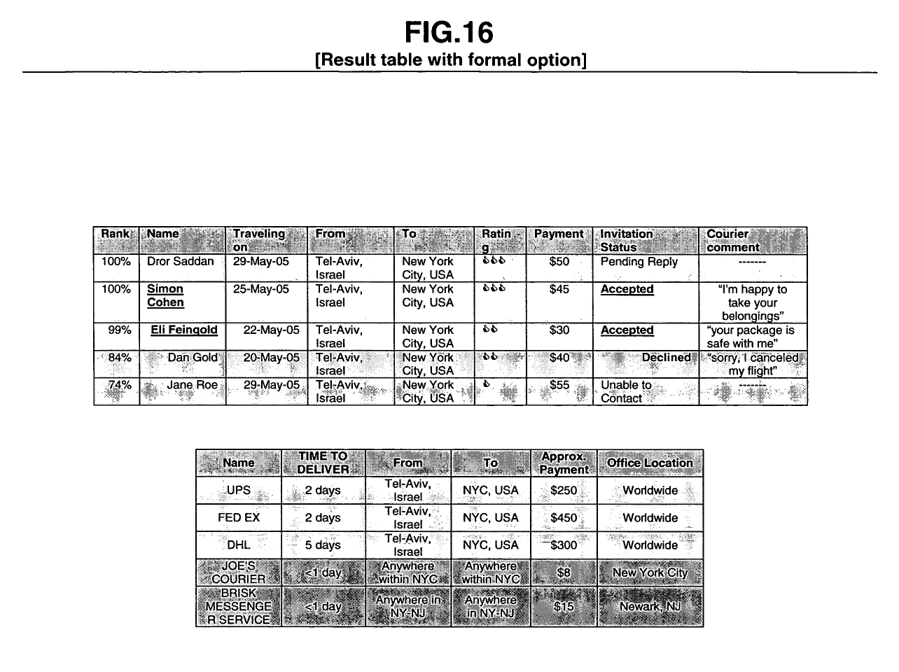

Prior to the meeting between the sender and the courier 129, the parties review TCC's suggested safety policies, available on the website, and arrange the meeting to take place in a well-lit, public location. The sender downloads and completes the “Courier Service Agreement” (“CSA”) (See FIG. 15), attesting to the true contents of the package that he is sending, and affirming that there are no dangerous or illegal items contained therein. Both parties photocopy their picture identification documents (e.g., passport, drivers license).

During the meeting 129 between the courier and the sender, the courier examines the package to thoroughly in the presence of the sender, making sure that the contents match the sender's declaration listed on the CSA. The parties then exchange photocopies of their identification documents, and review the terms of the transaction 131. The courier takes possession of the sender's package, and delivers it 132 to its destination.

In one aspect, where the sender deposited the courier's fee in escrow with TCC 130, the courier will inform the sender of successful delivery of the package. After verifying successful delivery, the sender forwards the courier an electronic pass code to retrieve payment for his services 133. Referring to FIG. 13, the courier requests payment by entering the pass code on his MyTCC 1316 screen. The system then updates the database 1318 and transfers funds, either manually or automatically, to the monetary account specified by the courier (e.g., credit card, bank account or PayPal).

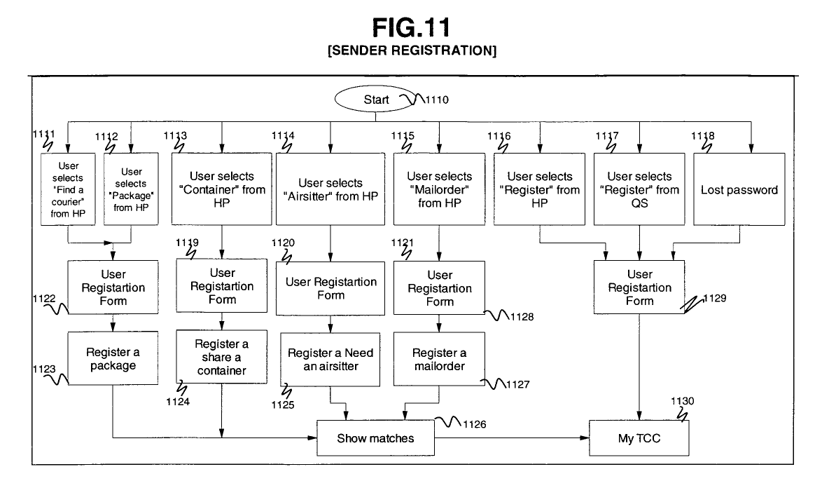

Finally, referring to FIG. 9, Overall Website Structure, the site sends an electronic survey to the courier 932 and sender 933 requesting the parties to rate one another for reliability and proficiency of service. The information is stored on the site's databases and accessible by future site users 925.

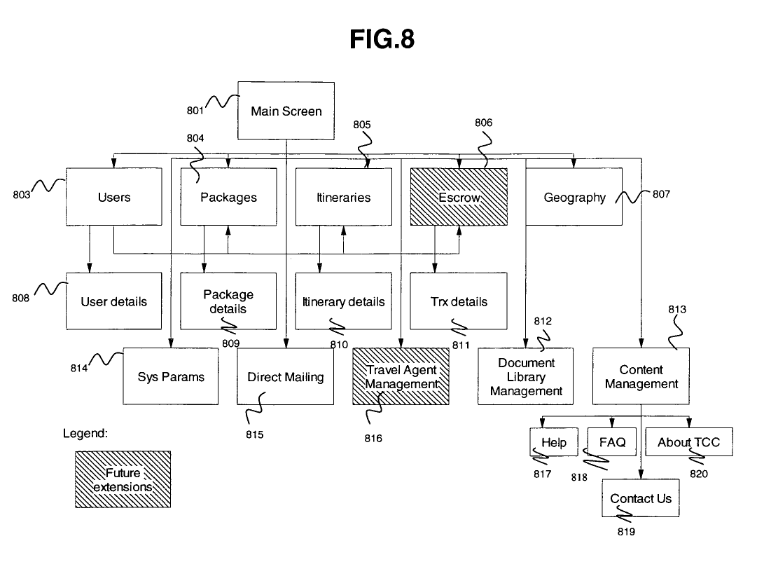

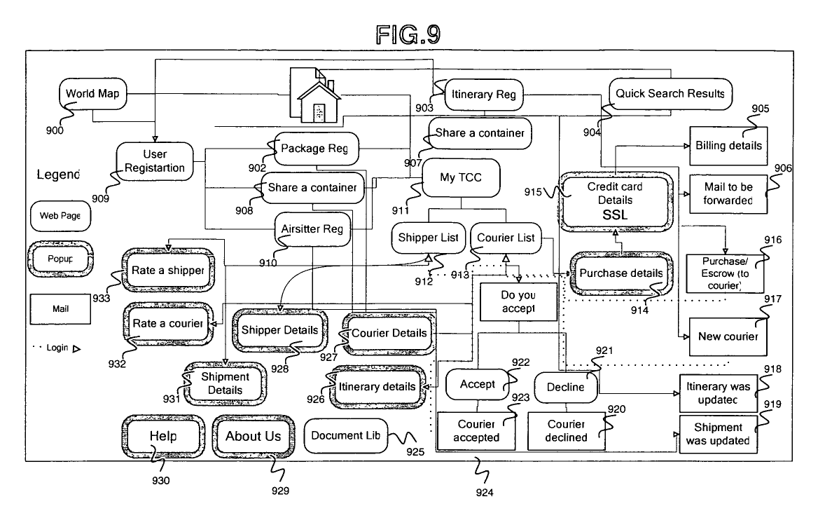

In another aspect, referring to FIG. 7, World Map, users can more quickly and more effortlessly review the number of available couriers 702 and senders 704 around the world by selecting a general destination on the world map 703, or choosing a country name from a drop-down menu. Various statistics about available delivery options will appear per destination (See also FIG. 7a).

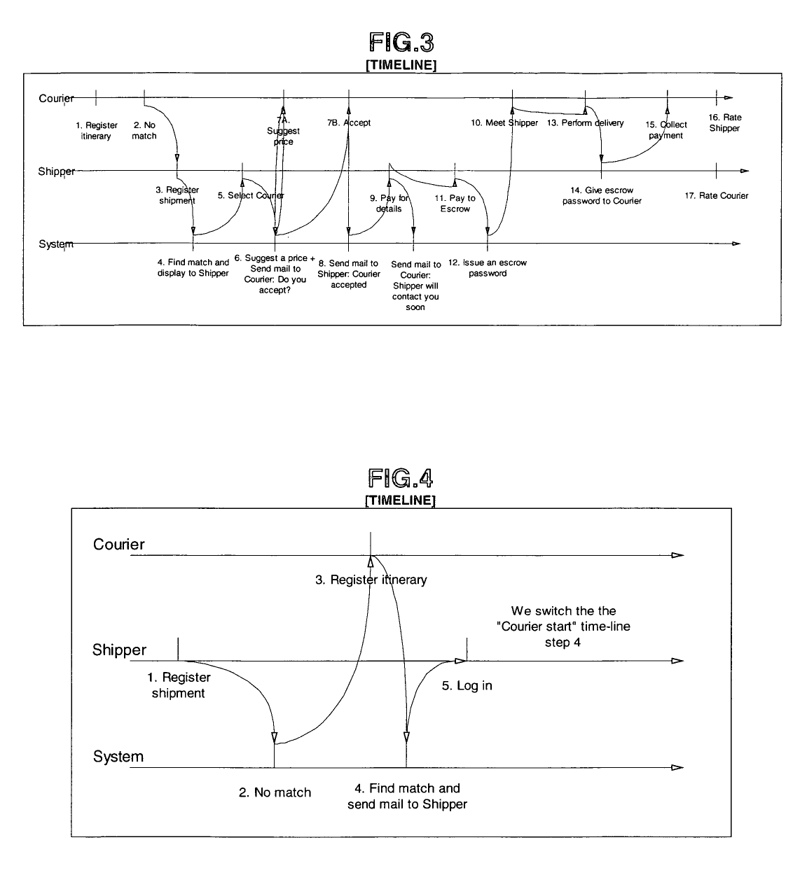

In a further aspect, for example, referring to FIG. 3, Timeline of the Matching Process, users are rated by other users 17 for reliability and performance. After all delivery transactions, users are sent an email survey form 16 and asked to rate the courier or sender 17. Referring back to FIG. 1, Flowchart of the Matching Process, this peer-generated reliability rating score is used by future users 121 to help determine which courier or sender is the most appropriate match for their needs. This data often influences which matching user will be invited to participate in a delivery 123.

In another aspect, referring to FIG. 11, the user may employ the system to receive a mail-order product 1115 from a company that does not ship to the users' locale or will only ship for very expensive delivery fees. For example, a sender registers on the website 1110 and selects the Mail-Order service 1115, indicating that he wishes to purchase a mail-order product delivered by casual courier. After completing the online registration form 1121, the system will identify available couriers 1126. The user selects a courier from his MyTCC screen 1130, and invites the courier to receive a mail-order package on his behalf. After the courier accepts the invitation, the user may purchase the contact information of the accepted courier. Then, when purchasing a product online or from a mail-order catalogue, the user provides the courier's mailing address to the company shipping the mail-order product. Upon receipt of the mail-order product, the courier delivers the product to the recipient, as set forth above.

In another aspect, the user may employ the system to receive share a shipping container 1113 when sending large cargo items via boat, truck or train. For example, a sender registers on the website 1110 and selects the Container Sharing service 1113, indicating that he wishes to rent space in another user's container. (Users may also offer space to rent out in his container). After completing the online registration form 1121, the system will identify available users 1126 who are offering space for rent in their containers. The user then selects an available container from his MyTCC screen 1130, and offers the owner of the container a fee for renting the space. After the container owner accepts the invitation, the user may purchase the contact information of the container owner. Then, the user may contact the container owner, and independently arrange delivery, as set forth above.

In another aspect, the user may employ the system to find an AirSitter 1114 to provide care for travelers who are young, old, or have special needs. For example, a mother traveling alone with young children registers on the website 1110 and selects the AirSitter service 1114, indicating that she wishes to find an AirSitter help watch over her children during her airline flight. (Users may also offer there services to care for travelers). After completing the online registration form 1121, the system will identify available AirSitters 1126 who are offering the service to care for travelers. An AirSitter will usually be matched with a user if their existing travel itineraries are similar. The mother then selects an available AirSitter from her MyTCC screen 1130, and offers the AirSitter a fee for the service. The AirSitter's fee can be arranged privately by the parties, or kept in escrow by TCC, as set forth above.

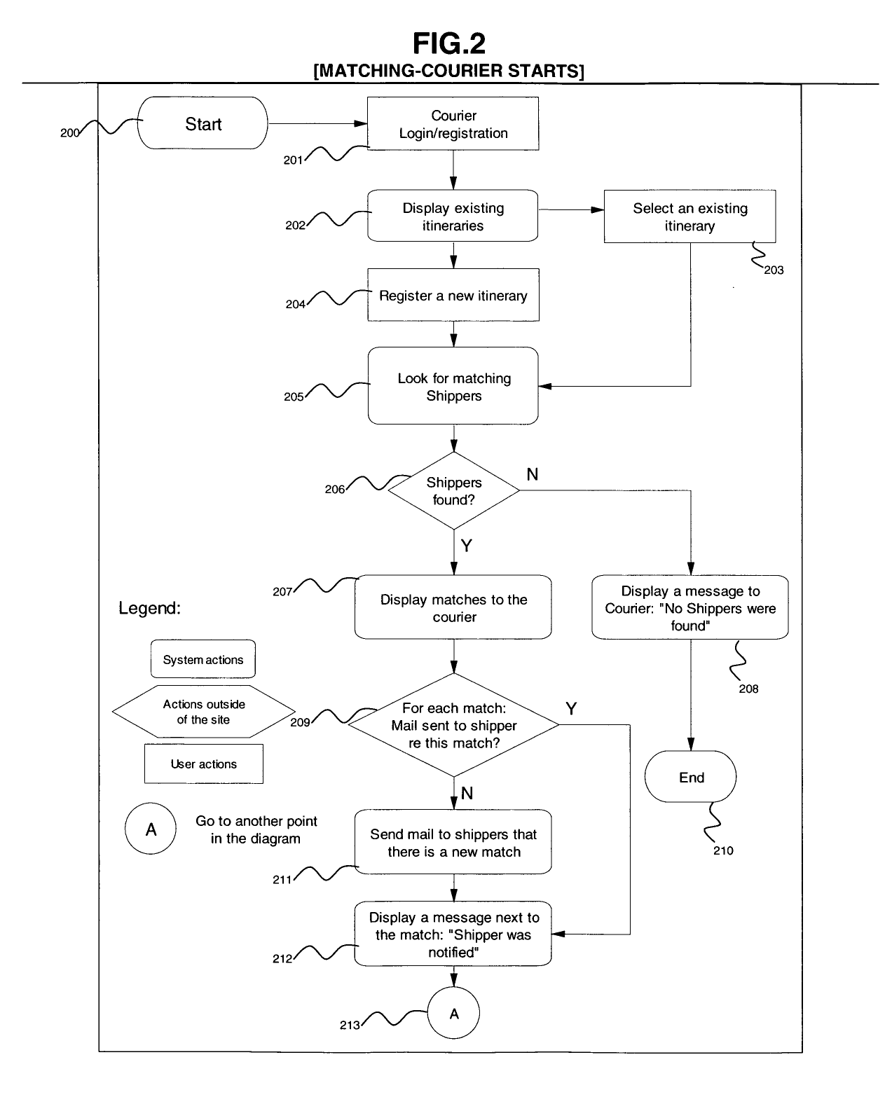

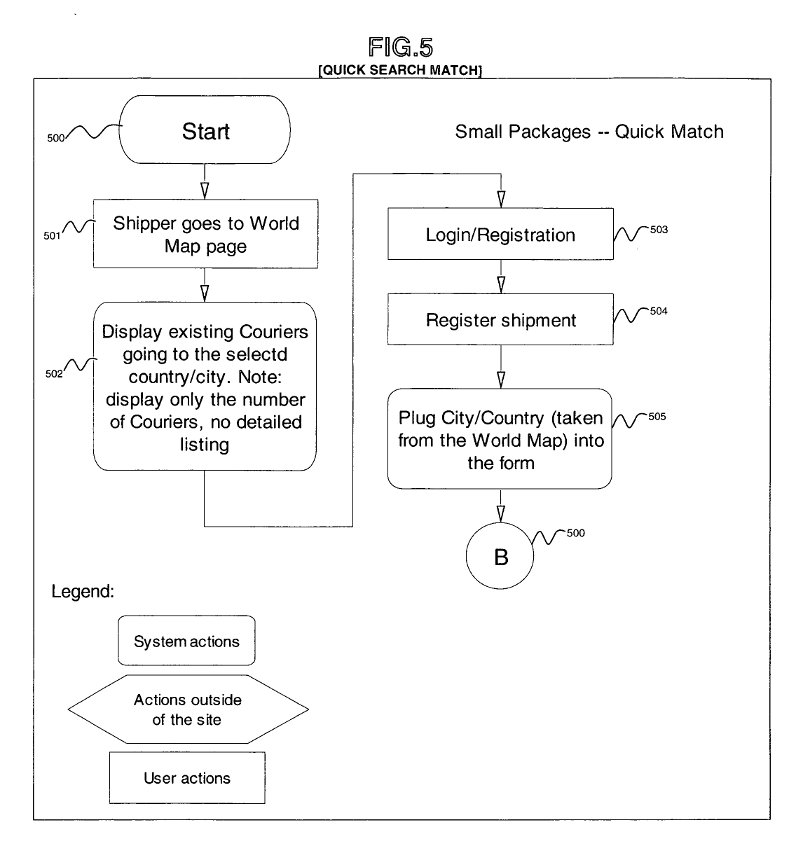

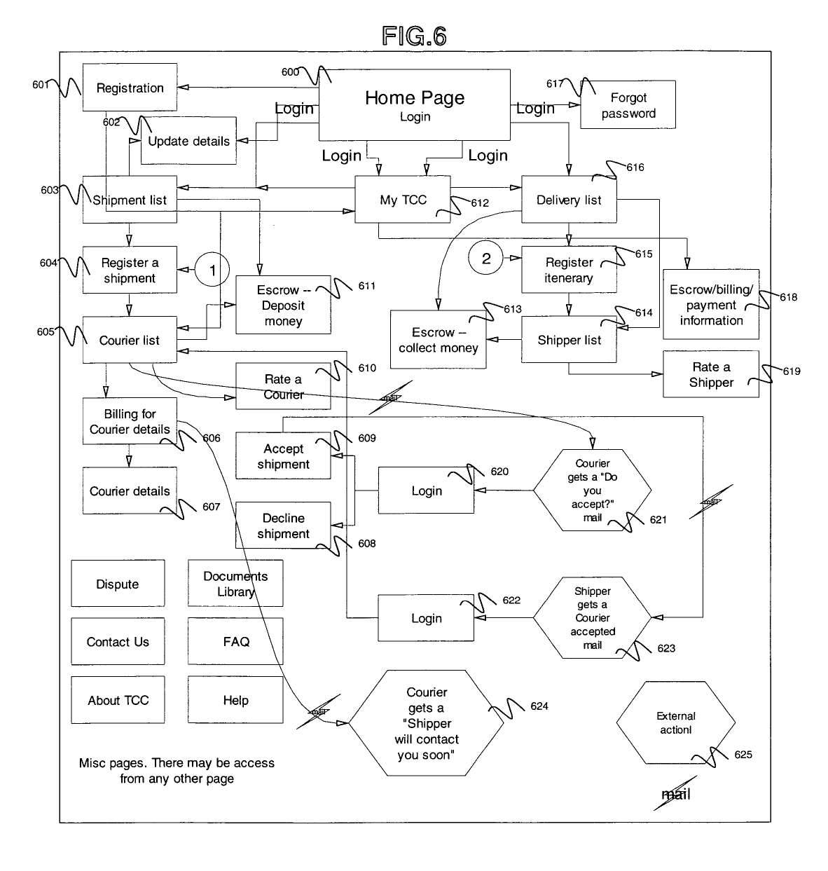

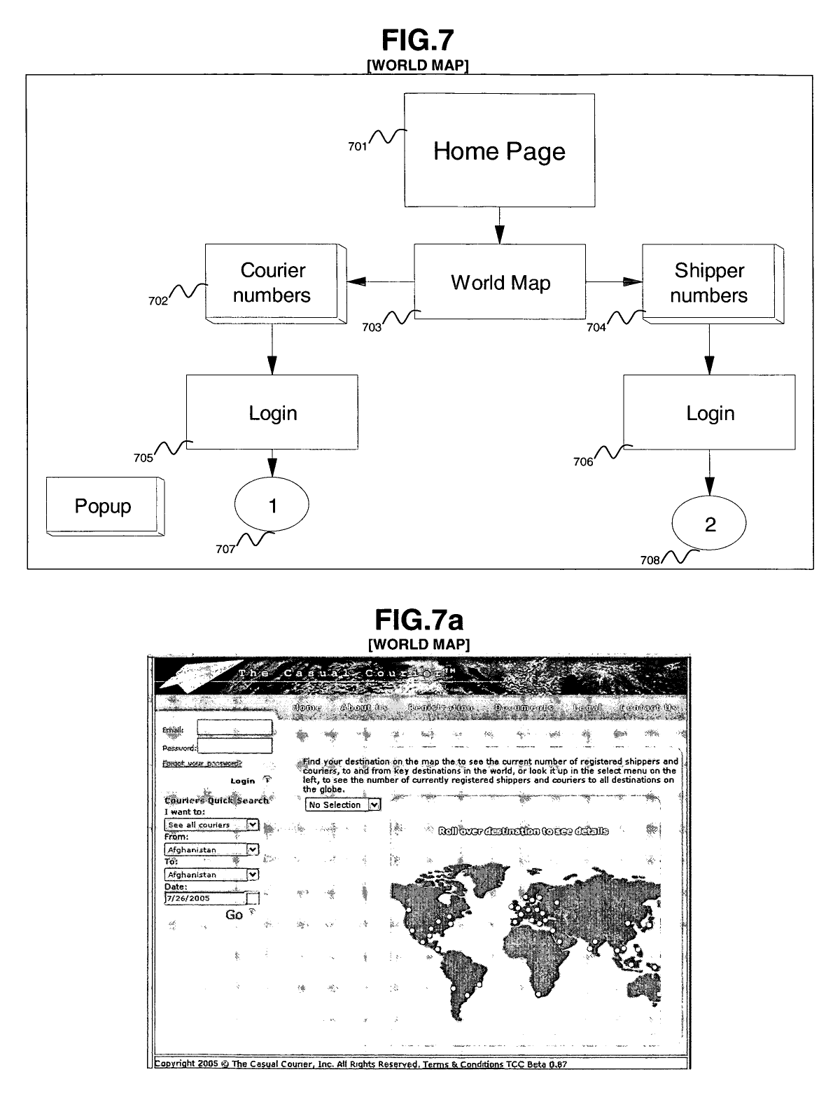

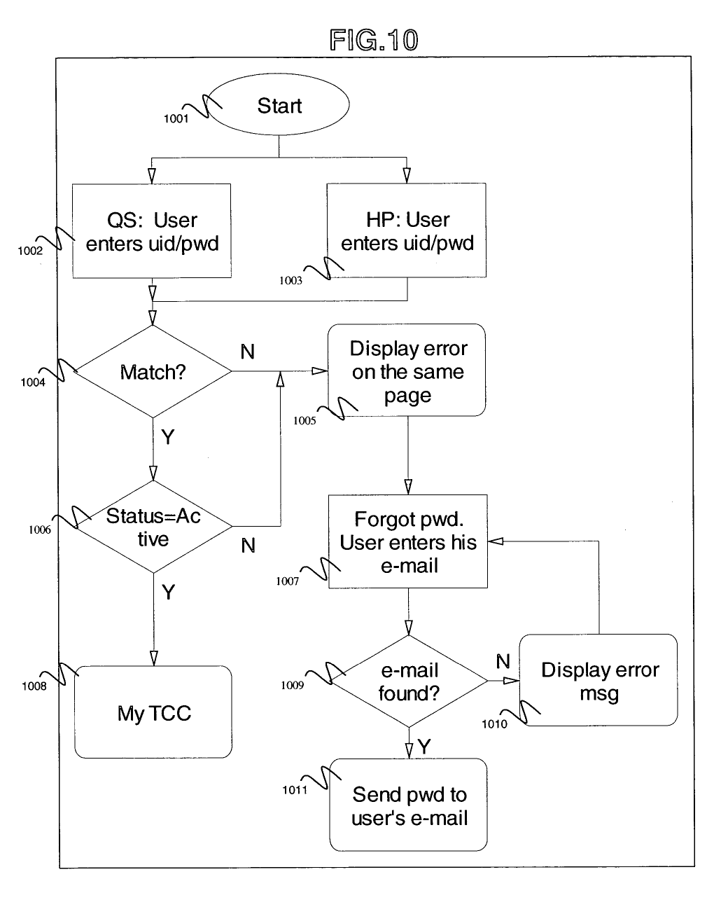

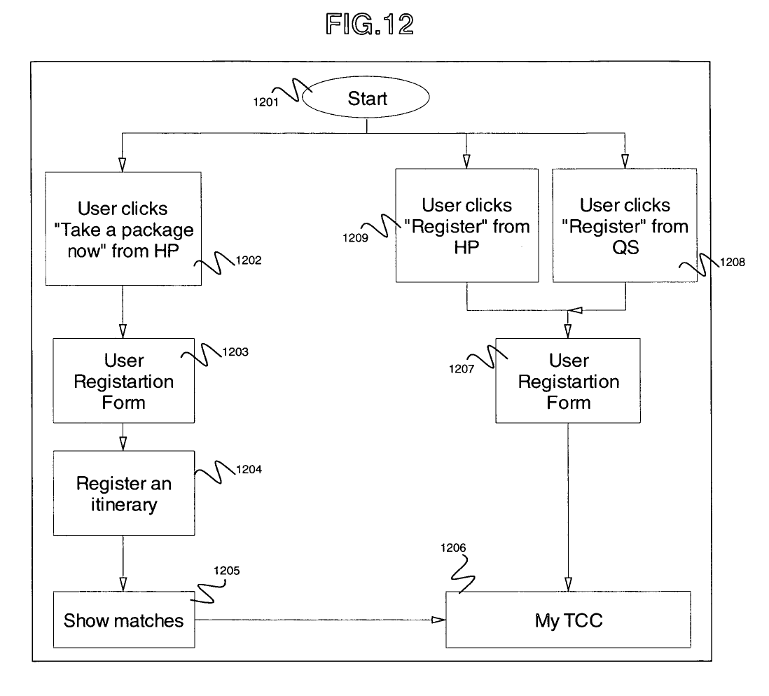

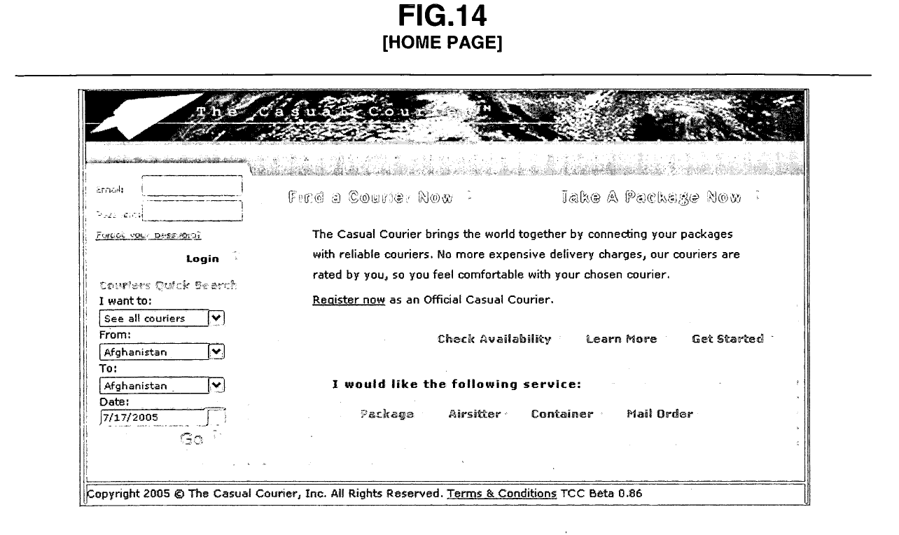

The system shown in FIG. 1-17, and described in-depth herein, has a number of significant benefits and advantages. For example, referring to FIG. 5, Quick-Search Match, users can enter the site 500 via the quick-search feature and find matching users more quickly and efficiently than the traditional matching means. By indicating a few details (namely, the service required, point of departure, point of destination, and date required), users can quickly and easily locate a brief, general listing of the couriers and senders that are currently available within a particular delivery route 502.

An additional advantage of the system is to allow users the ability to send packages domestically and internationally for lower costs, with faster delivery times, and with a high degree of reliability. In other words, by negotiating delivery with independent couriers, who are already enroute to a desired destination, users can drastically reduce the cost of delivery, while simultaneously improving speed and dependability.

A further benefit of the system is to allow hand-delivery of fragile, precious, important, time-sensitive, and valuable items to be delivered in a much more cost effective manner than traditional courier hand-delivery. By privately contracting independent travelers will to be casual couriers, the cost for hand delivery is drastically reduced.

A further benefit of the system is to allow users in locations where mail-order deliveries will not send to users, or will only send to users for prohibitively high delivery fees, the ability to receive mail-order and catalogue products via casual courier (i.e., hand-delivery). This will expand the market of online and catalogue mail-order sales worldwide.

A further benefit of the system is to allow users to find AirSitters and thereby allow travelers with children, children traveling alone, travelers with special needs, and elderly passengers to receive in-flight or in-transit care and assistance while traveling.

A computer system for implementing the system of FIG. 1 typically includes at least one main unit connected to both an output device which displays information to a user and an input device which receives input from a user. The main unity may include a processor connected to a memory system via an interconnection mechanism. The input device and output device are also connected to the processor and memory system via the interconnection mechanism.

It should be understood that one or more output devices may be connected to the computer system. Example output devices include cathode ray tubes (CRT) display, liquid crystal displays (LCD) and other video output devices, printers, communications devices such as modem, storage devices such as a disk or tape and audio output. It should also be understood that one or more input devices may be connected to the computer system. Example input devices include a keyboard, keypad, mouse, pen and tablet, communication device, and date input device such as audio and video capture devices. It should also be understood that the invention is not limited to the particular input or output devices used in combination with the computer system or to those described herein.

The computer system may be a general purpose computer system which is programmable using a computer programming language such as C++, Java, or other language, such as a scripting language or assembly language. The computer system may also include specially programmed, special purpose hardware. In a general purpose computer system, the processor is typically a commercially available processor, of which the series x86, Celeron, and Pentium processors, available from Intel, and similar devices from AMD and Cyrix, the 680X0 series microprocessors available from Motorola, the PowerPC microprocessors available from IBM and the Alpha-series processors fro Digital Equipment Corporation, are examples. Many other processors are available. Such a microprocessor executes a program called an operating system, of which Windows NT, Windows XP, Linux, UNIX, DOS, VMS, OS8 are examples, which controls the execution of other computer programs and provides scheduling, debugging, input/output control, accounting, compilation, storage assignment, data management, and communication control and related services. The processor and operating system define a computer platform for which application programs in high-level programming languages are written.

A memory system typically includes a computer readable and writeable nonvolatile recording medium, of which magnetic disk, a flash memory and tape are examples. The disk may be removable, know as a floppy disk, or permanent, known hard drive. A disk has a number of tracks in which signal are stored, typically in binary form, i.e., a form interpreted as a sequence of one and zeros. Such signals may define an application program to be executed by the processor, or information stored on the disk to be processed by the application program. Typically, in operation, the processor causes data to be read from the nonvolatile recording medium into an integrated circuit memory element, which is typically a volatile, random access memory element, such as a dynamic random access memory (DRAM) or static memory (SRAM). The integrated circuit memory element allows for faster access to the information by the processor than does the disk. The processor generally manipulates the data within the integrated circuit memory and then copies the data to the disk when processing is completed. A variety of mechanisms are known for managing data movement between the disk and the integrated circuit memory element, and the invention is not limited thereto. It should also be understood that the invention is not limited to a particular memory system.

The invention is not limited to a particular computer platform, particular processor, or particular high-level programming language. Additionally, the computer system may be a multiprocessor computer system or may include multiple computers connected over a computer network. The email system may be embodied a separate computer programs. Such modules may be operable on separate computers. Data may be stored in a memory system or transmitted between computer systems. The invention is not limited to any particular implementation using software or hardware or firmware, or any combination thereof. The various elements of the system, either individually or in combination, may be implemented as computer program product tangibly embodied in a machine-readable storage device for execution by a computer processor. Various steps of the process may be performed by a computer processor executing a program tangibly embodied on a computer-readable medium to perform functions by operating on input and generating output. Computer programming languages suitable for implementing such a system include procedural programming languages, object-oriented programming languages, and combinations of the two.

While illustrative embodiments of various aspects of the invention have been described, the invention is not limited to the embodiments described. Many alternatives, modifications and variations of the embodiments described will be apparent to those skilled in the art. Accordingly, embodiments of the invention as set forth herein are illustrative and not limiting. The invention is limited only by the following claims and equivalents thereto.

What is claimed is:

1. A method of matching a people to achieve delivery of packages, the method comprising:
(a) obtaining preferences from a user with a package to deliver;
(b) obtaining preferences from a traveler willing to deliver a package;
(c) determining whether the preferences of the user and the traveler are consistent; and
(d) if the preferences of the user and the traveler are consistent, allowing the user to anonymously contact the traveler to arrange delivery of the user's package.

2. The method of claim 1, wherein steps (a) and (b) are performed over a communications network.

3. The method of claim 1, further comprising the step of searching a database to find a traveler whose preferences match the preferences of the user.

4. The method of claim 3, further comprising the step of providing characteristics of the traveler to the user, the characteristics of the traveler including an identification number, a peer-generated reliability rating, and desired package delivery fees.

5. The method of claim 1, wherein step (a) comprises providing a registration form to the user to request preference information and step (b) comprises providing a registration form to the traveler to request preference information.

6. The method of claim 1, wherein the user and the traveler are permitted to independently negotiate a fee for delivery of the user's package.

7. The method of claim 6, wherein the fee is held in escrow until the user's package has been delivered by the traveler.

8. The method of claim 5, further comprising the step of requiring the user to execute a signed document disclosing the contents of the user's package.

9. The method of claim 1, further comprising the step of arranging a meeting between the user and the traveler at which the user provides the user's package to the traveler for delivery to another location.

10. The method of claim 9, wherein the meeting occurs in a public place.

11. The method of claim 10, wherein the user and the traveler exchange copies of their passports during the meeting.

12. The method of claim 9, wherein the traveler flies on an airplane before delivering the user's package.

13. The method of claim 12, wherein the traveler flies to another country before delivering the user's package.

14. A method of arranging in-transit assistance, the method comprising:
(a) obtaining preferences from a user who desires in-transit assistance;
(b) obtaining preferences from a traveler willing to provide in-transit assistance;
(c) determining whether the preferences of the user and the traveler are consistent; and
(d) if the preferences of the user and the traveler are consistent, allowing the user to anonymously contact the traveler to arrange in-transit assistance.

15. The method of claim 14, wherein the user's preferences comprise a destination to which the user desires to travel.

16. The method of claim 15, wherein the user desires to travel by airplane.

17. The method of claim 15, wherein the user desires to travel by train.

18. The method of claim 14, wherein steps (a) and (b) are performed over a communications network.

19. The method of claim 14, further comprising the step of searching a database to find a traveler whose preferences match the preferences of the user.

20. A method of arranging mail-order forwarding, the method comprising:
identifying a mail-order company;
identifying a first location to which the mail-order company does not deliver;
identifying a second location to which the mail-order company does delivery;
obtaining mail-order delivery preference information from a user who resides in the first location;
searching a database of users who reside in the second location;
identifying a user who resides in the second location and is willing to place an order from the mail-order company on behalf of the user who resides in the first location and bring the order to the user who resides in the first location.
